(19) United States
(12) Patent Application Publication
(10) Pub. No.: US 2014/0161698 A1
(43) Pub. Date: Jun. 12, 2014

(54) SYSTEM AND METHOD FOR PROCESSING RECIRCULATION AIR

(71) Applicant: Airbus Operations GmbH, Hamburg (DE)

(72) Inventor: Frank Klimpel, Hamburg (DE)

(21) Appl. No.: 14/097,993

(22) Filed: Dec. 5, 2013

Related U.S. Application Data
(60) Provisional application No. 61/734,384, filed on Dec. 7, 2012.

(30) Foreign Application Priority Data
Dec. 7, 2012 (EP) 12196003.3

(51) Int. Cl. B64D 13/08; B01D 53/18; B64D 13/06; B01D 53/14

(52) U.S. Cl. CPC B64D 13/08; B01D 53/1425; B01D 53/18; B01D 53/1475; B64D 13/06
USPC 423/228; 422/123; 422/125

(57) ABSTRACT

A system for processing recirculation air discharged from an aircraft cabin comprising a recirculation air supply line which is connectable to the aircraft cabin so as to allow a flow of recirculation air discharged from the aircraft cabin therethrough. An absorber is connected to the recirculation air supply line and is adapted to remove CO₂ from the recirculation air flowing through the recirculation air supply line by absorption of CO₂ in a provided absorption medium. A recirculation air discharge line is connected to the absorber and is connectable to the aircraft cabin so as to allow a flow of absorption treated recirculation air exiting the absorber to the aircraft cabin. Finally, an air processing device is disposed in the recirculation air discharge line, wherein the air processing device is connected to an O₂ source and is adapted to enrich the recirculation air exiting the absorber with O₂.

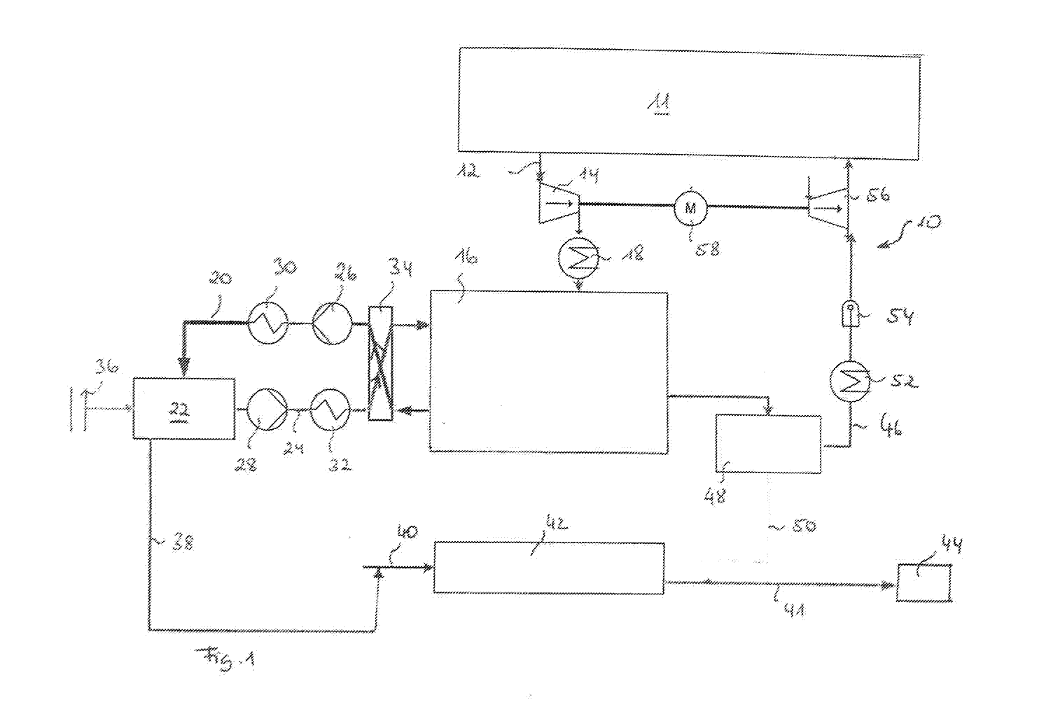

### CROSS-REFERENCES TO RELATED APPLICATIONS

This application claims the benefit of the U.S. Provisional Application No. 61/734,384, filed on Dec. 7, 2012, and of the European patent application No. 12 196 003.3 filed on Dec. 7, 2012, the entire disclosures of which are incorporated herein by way of reference.

### BACKGROUND OF THE INVENTION

The present invention relates to a system and a method for processing recirculation air discharged from an aircraft cabin.

The cabin of a modem passenger aircraft typically is air-conditioned by means of an air conditioning system, as described for example in DE 10 2008 053 320 A1 and US 2010/101251 A1 or DE 10 2010 054 448 A1 and WO 2012/079756 A2. The air conditioning system typically comprises an air conditioning unit which is supplied with compressed process air that is generated by a compressor or bled off from an engine or an auxiliary power unit (APU) of the aircraft. In the air conditioning unit, the process air, upon flowing through at least one heat exchanger as well as through various compression and expansion units, is cooled and expanded. Cooled process air exiting the air conditioning unit finally is supplied to a mixing chamber where it is mixed with recirculation air recirculated from an aircraft region to be air conditioned. The mixed air from the mixing chamber, via respective mixed air lines, is supplied to the aircraft region to be air conditioned.

During operation of the aircraft, the CO2 content of the air in the aircraft cabin and hence also in the recirculation air discharged from the aircraft cabin increases due to the breathing air consumption of the passengers in the aircraft cabin. To prevent the CO2 content of the air in the aircraft cabin exceeding a statutory threshold value of 0.5% the recirculation air discharged from the aircraft cabin, in the mixing chamber of the air conditioning system, may be mixed with a suitable amount of cooled process air supplied to the mixing chamber from the air conditioning unit. Further, as described in DE 43 35 152 C1 or U.S. Pat. No. 5,516,330, the recirculation air discharged from the aircraft cabin, before being supplied to the mixing chamber of the air conditioning system, may be directed through a CO2 absorber. The CO2 absorber according to DE 43 35 152 C1 or U.S. Pat. No. 5,516,330 comprises a CO2 filter, in particular a solid amine filter.

The invention is directed at the object of specifying a system and a method for processing recirculation air discharged from an aircraft cabin which allow the provision of high quality recirculation air.

### SUMMARY OF THE INVENTION

A system for processing recirculation air discharged from an aircraft cabin comprises a recirculation air supply line which is connectable to the aircraft cabin so as to allow a flow of recirculation air discharged from the aircraft cabin therethrough. The flow of recirculation air from the aircraft cabin into the recirculation air supply line may be controlled by at least one suitable valve. The recirculation air flowing through the recirculation air supply line may have a CO2 content of up to approximately 0.5%. Further, the recirculation air may contain approximately 20.1% O2.

The system for processing recirculation air further comprises an absorber which is connected to the recirculation or supply line and which is adapted to remove CO2 from the recirculation air flowing through the recirculation air supply line by absorption of CO2 in an absorption medium. A recirculation air discharge line is connected to the absorber and is connectable to the aircraft cabin so as to allow a flow of absorption treated recirculation air exiting the absorber to the aircraft cabin. Preferably, the absorption treated recirculation air exiting the absorber has a CO2 content of approximately 0.04%. Further, the absorption treated recirculation air at the exit of the absorber may contain approximately 20.1% O2. The recirculation air discharge line may directly open into the aircraft cabin. Preferably, however, the recirculation air discharge line opens into a mixing chamber wherein the recirculation air may, for example, be mixed with process air provided to the mixing chamber from an air conditioning unit.

Finally, an air processing device is disposed in the recirculation air discharge line. The air processing device is connected to an oxygen source and is adapted to enrich the recirculation air exiting the absorber with O2. For example, the O2 source may be adapted to supply a gas stream having an O2 content of up to approximately 35% to the air processing device. In the air processing device, the O2 content of the recirculation air exiting the absorber may be increased from approximately 16% to approximately 21%. As a result, the recirculation air flowing through the recirculation air discharge line downstream of air processing device may contain approximately 21% O2 and approximately 0.04% CO2.

The system for processing recirculation air provides high quality recirculation air. In particular, the system allows to very effective and efficiently reduce the CO2 content of the recirculation air discharged from the aircraft cabin. Further, the recirculation air treated by the system for processing recirculation air has an O2 content which is comparable to the O2 content of fresh ambient air. As a result, a supply of fresh ambient air to the recirculation air so as to increase the O2 content of the recirculation air can be omitted or at least significantly reduced. Further, the amount of fresh process air provided, for example, by an air conditioning unit and mixed with the recirculation air, for example in a mixing chamber, can be reduced.

The O2 source connected to the air processing device preferably is a fuel tank inerting system. A typical fuel tank inerting system is supplied with ambient air. In the fuel tank inerting system, the O2-content of the ambient air is reduced, wherein O2 occurs as a waste product which in prior art inerting systems is discharged to the ambient atmosphere. In the system for processing recirculation air, the O2 occuring as a waste product in the fuel tank inerting system is used to increase the O2 content of the recirculation air which further increases the efficiency of the system for processing recirculation air.

Preferably, the absorber is adapted to remove CO2 from the recirculation air flowing through the recirculation air supply line by absorption of CO2 in a liquid absorption medium. The absorber thus may act as a gas scrubbing device, i.e., a device wherein a CO2 containing recirculation air flow is introduced in the liquid absorption medium so as to remove the CO2 from the recirculation air flow. In general, the liquid absorption medium may be any liquid absorption medium which is suitable to remove CO2 from an air stream, either by physical absorption or by chemical absorption. Parameters which may be observed upon selecting the liquid absorption medium may for example be the toxicity, the effectiveness and the odour of the liquid absorption medium as well as the desired purity of the recirculation air. Preferably, however, the liquid absorption medium is a liquid absorption medium which allows a chemical absorption of CO2. Liquid absorption media which allow a chemical absorption of CO2 are in particular suitable to effectively remove CO2 from a gas stream containing CO2 at a low partial pressure. For example, water, GenosorbN® (Polymethyldiglycolamine) or a mixture of GenosorbN® and water may be used as the liquid absorption medium in the absorber of the system for processing recirculation air.

The absorber, for example, may be designed in the form of an absorber tube allowing a flow of recirculation air to be treated therethrough, wherein nozzles for spraying the liquid absorption medium into the recirculation air flow may be provided, for example, in the region of a wall of the absorber tube. A tube-shaped absorber requires only a small installation space and thus is in particular suitable for use on board an aircraft. It is, however, also conceivable to integrate the absorber into a mixing chamber for mixing recirculation air with, for example, process air provided from an air conditioning unit. The considerable height of construction of the mixing chamber allows the integration of an absorber having a large passage length allowing a very effective and very efficient operation of the absorber.

Preferably, the system for processing recirculation air discharged from an aircraft cabin further comprises an absorption medium discharge line having a first end connected to the absorber. A second end of the absorption medium discharge line may be connected to a desorber. The absorption medium discharge line thus allows a flow of CO2 loaded liquid absorption medium from the absorber to the desorber. The CO2 loaded absorption medium may, for example, be a sodium carbonate solution. Further, an absorption medium supply line may be present which has a first end connected to the desorber and a second end connected to the absorber. The absorption medium supply line thus allows a flow of regenerated liquid absorption medium from the desorber to the absorber.

The desorber may be connectable to the ambient atmosphere and may be adapted to operate under a reduced ambient pressure prevailing in an unpressurized region of an aircraft during flight operation of the aircraft. In other words, when the system for processing recirculation air discharged from an aircraft cabin is installed in an aircraft, the desorber may be connected to the ambient atmosphere so as to expose the desorber to the ambient pressure, in particular the reduced ambient pressure which prevails outside of the aircraft as well as in an unpressurized region of the aircraft during flight operation of the aircraft, for example when the aircraft is flying at cruising altitude. For example, the desorber may be adapted to operate under a pressure of approximately 0.2 bar.

For example, the desorber, may be installed in an unpressurized region of the aircraft. It is, however, also conceivable to install the desorber within a pressurized region of the aircraft, but to connect the desorber, for example, via a suitable fluid line, to the ambient atmosphere outside of the aircraft or the unpressurized region of the aircraft. The low pressure prevailing in the desorber during flight operation of the aircraft allows a high desorption rate to be achieved. Heating of the CO2 loaded absorption medium in the desorber or heating of the CO2 loaded absorption medium prior to supplying the CO2 loaded absorption medium to the desorber or evacuating the desorber, for example by means of a suitable pump, thus can be omitted. Hence, a particularly efficient operation of the system for processing recirculation air can be achieved or at least significantly reduced.

A discharge conveying device may be disposed in the absorption medium discharge line for conveying CO2 loaded absorption medium from the absorber to the desorber. The discharge conveying device may, for example, be designed in the form of a pump. Further, a pre-heater may be disposed in the absorption medium discharge line. For example, the pre-heater may be disposed in the absorption medium discharge line downstream of the discharge conveying device. The pre-heater serves to pre-heat the CO2 loaded absorption medium prior to being supplied to the desorber. Pre-heating of the CO2 loaded absorption medium enhances the desorption efficiency of the desorber and is particularly advantageous when the desorber is operated during ground operation of the aircraft, i.e. when the desorber has to be operated under normal ambient pressure.

A supply conveying device may be disposed in the absorption medium supply line. Like the discharge conveying device, the supply conveying device also may be designed in the form of a pump. Further, a cooler may be disposed in the absorption medium supply line, for example downstream of the supply conveying device. The cooler serves to cool the regenerated absorption medium flowing through the absorption medium supply line prior to be supplied back to the absorber. Finally, it is conceivable to thermally couple the absorption medium discharge line to the absorption medium supply line so as to transfer heat from the regenerated absorption medium flowing through the absorption medium supply line to the CO2 loaded medium flowing through the absorption medium discharge line. The thermal coupling between the absorption medium discharge line and the absorption medium supply line, for example, may be achieved by means of a heat exchanger.

Preferably, the desorber is connectable to a ram air channel so as to allow a flow of ram air through the desorber and to thus purge CO2 desorbed from the absorption medium from the desorber. Further, the desorber may be connected to the fuel tank inerting system so as to allow CO2 purged from the desorber to be supplied to the fuel tank inerting system. The fuel tank inerting system usually is supplied with ambient air and generates a gas to be supplied to a fuel tank so as to inert the fuel tank which usually contains N2, CO2 and noble gases and has an O2 content which is significantly lower than the O2 content of ambient air for rendering the gas inflammable. The supply of CO2 which occurs as a waste product in the desorption process carried out in the desorber to the fuel tank inerting system thus increases the CO2 content of the gas supplied to the fuel tank inerting system.

In a preferred embodiment of the system for processing recirculation air, the system further comprises a compressor which is disposed in the recirculation air supply line and which is adapted to compress the recirculation air flowing through the recirculation air supply line. When the recirculation air is compressed by means of a compressor, an additional conveying device for conveying the recirculation air through the system for processing recirculation air can be omitted. Further, the recirculation air is supplied to the absorber at an elevated pressure allowing a high absorption efficiency of the absorber to be achieved. Specifically, the compressor may be operated, for example, under the control of a suitable control unit, such that the recirculation air flowing through the recirculation air supply line, prior to being supplied to the absorber, is compressed to a pressure suitable for optimizing the CO2 absorption in the absorber.

Further, a turbine may be disposed in the recirculation air discharge line. The turbine may be adapted to expand the recirculation air flowing through the recirculation air discharge line. As discussed above, the recirculation air, by means of a compressor, may compressed to a desired elevated pressure so as to enhance the absorption efficiency in the absorber. The turbine then may serve to again reduce the pressure of the recirculation air, preferably to a pressure level at which the recirculation air is suitable to be directed to the aircraft cabin, either directly or via a mixing chamber. Preferably, the turbine is adapted to drive the compressor. As a result, the output of a motor driving the compressor may be reduced. For example, the turbine may be disposed with the compressor on a common shaft. A motor driving the compressor also may be disposed on the common shaft connecting the turbine and the compressor.

The system for processing recirculation air further may comprise a heat exchanger disposed in the recirculation air supply line and being adapted to cool the recirculation air flowing through the recirculation air supply line to a first predetermined temperature. Preferably, the heat exchanger is disposed in the recirculation air supply line downstream of the compressor. The first predetermined temperature preferably is a temperature suitable for optimizing the CO2 absorption in the absorber.

Moreover, a further heat exchanger may be disposed in the recirculation air discharge line which is adapted to cool the recirculation air flowing through the recirculation air discharge line to a second predetermined temperature. Preferably, the further heat exchanger is disposed in the recirculation air discharge line upstream of the turbine. The second predetermined temperature preferably is a temperature suitable for allowing the recirculation air to be directed to the turbine and, therafter, to the aircraft cabin, either directly or via a mixing chamber.

A water separator may be disposed in the recirculation air discharge line. Preferably, the water separator is disposed in the recirculation air discharge line downstream of the further heat exchanger and serves to remove water condensed from the recirculation air flow upon being cooled in the further heat exchanger from the recirculation air flow. Preferably, the water separator is designed in the form of a high pressure water separator and also is suitable to remove residual liquid absorption medium which may be present in the recirculation air flowing through the recirculation air discharge line from the recirculation air flow.

In a method for processing recirculation air discharged from an aircraft cabin, a flow of recirculation air discharged from the aircraft cabin is guided through a recirculation air supply line. CO2 is removed from the recirculation air flowing through the recirculation air supply line in an absorber by absorption of CO2 in an absorption medium. A flow of treated recirculation air exiting the absorber is guided through a recirculation air discharge line to the aircraft cabin. The recirculation air exiting the absorber is enriched with O2 by means of an air processing device which is disposed in the recirculation air discharge line and which is connected to an O2 source.

The O2-source preferably is a fuel tank inerting system.

Preferably, a flow of CO2 loaded liquid absorption medium is guided from the absorber to a desorber through an absorption medium discharge line having a first end connected to the absorber and a second end connected to the desorber. A flow of regenerated liquid absorption medium may be guided from the desorber to the absorber through an absorption medium supply line having a first end connected to the desorber and a second end connected to the absorber. The desorber may be connectable to the ambient atmosphere and may be adapted to operate under reduced ambient pressure prevailing in an unpressurized region of an aircraft during flight operation of the aircraft. In particular, operation of the desorber may be controlled, for example by means of a suitable control unit, such that the desorber preferably is operated during flight operation of the aircraft. The system and the method of processing recirculation air thus uses the pressure differences present on board an aircraft during flight operation of the aircraft for enhancing the efficiency of recirculation air processing.

The method for processing recirculation air may further comprise the step of conveying the CO2 loaded absorption medium from the absorber through the absorption medium discharge line by means of a discharge conveying device. Further, the CO2 loaded absorption medium flowing through the absorption medium discharge line may be pre-heated by means of a pre-heater. The regenerated absorption medium exiting the desorber may be conveyed though the absorption medium supply line by means of a supply conveying device. The regenerated absorption medium flowing through the absorption medium supply line may be cooled by means of a cooler.

In the method for processing recirculation air, a flow of ram air may be guided from a ram air channel through the desorber so as to purge CO2 desorbed from the absorption medium from the desorber. CO2 purged from the desorber may be supplied to a fuel tank inerting system.

The recirculation air flowing through the recirculation air supply line may be compressed by means of a compressor disposed in the recirculation air supply line. Further, the recirculation air flowing through the recirculation air discharge line may be expanded by means of a turbine disposed in the recirculation air discharge line.

The recirculation air flowing through the recirculation air supply line may be cooled to a first predetermined temperature by means of a heat exchanger disposed in the recirculation air supply line. The first predetermined temperature preferably is a temperature suitable for optimizing the CO2 absorption in the absorber. The recirculation air flowing through the recirculation air discharge line may be cooled to a second predetermined temperature by means of a second heat exchanger disposed in the recirculation air discharge line. The second predetermined temperature may be a temperature suitable for allowing the recirculation air to be directed to the turbine and, thereafter, to the aircraft cabin.

In the method for processing recirculation air, water may be separated from the recirculation air flowing through the recirculation air discharge line by means of a water separator disposed in the recirculation air discharge line. Further, residual liquid absorption medium which may be present in the recirculation air flowing through the recirculation air discharge line may be separated from the recirculation air flow in the water separator.

### BRIEF DESCRIPTION OF THE DRAWINGS

A preferred embodiment of a process and a method for processing recirculation air discharged from an aircraft cabin now is described in greater detail with reference to the appended schematic drawing, wherein

The FIGURE shows a schematic diagram of a system for processing recirculation air discharged from an aircraft cabin.

### DETAILED DESCRIPTION OF THE PREFERRED EMBODIMENTS

The FIGURE shows a system 10 for processing recirculation air discharged from an aircraft cabin 11. The system 10 comprises a recirculation air supply line 12 which is connectable to the aircraft cabin 11. The flow of recirculation air from the aircraft cabin 11 into the recirculation air supply line 12 may be controlled by a suitable valve (not shown). The recirculation air flowing through the recirculation air supply line 12 contains approximately 20.1% O2 and approximately ≦0.5% CO2.

A compressor 14 is disposed in the recirculation air supply line 12 which serves to compress the recirculation air flowing through the recirculation air supply line 12. Since the compressor 14 compresses the recirculation air flowing through the recirculation air supply line 12 to an elevated pressure, an additional conveying device for conveying the recirculation air through the system 10 can be omitted. Further, the compressor 14 compresses the recirculation air flowing through the recirculation air supply line to a pressure which is suitable for optimizing the CO2 absorption in an absorber 16 which is connected to the recirculation air supply line 12 downstream of the compressor 14. Finally, a heat exchanger 18 is disposed in the recirculation air supply line 12. The heat exchanger 18 cools the recirculation air flowing through the recirculation air supply line 12 to a temperature which is suitable for optimizing the CO2 absorption in the absorber 16.

The absorber 16 serves to remove CO2 from the recirculation air, i.e. to reduce the CO2 content of the recirculation air supplied to the absorber 16 via the recirculation air supply line 12. In the absorber 16, the recirculation air is directed through a liquid absorption medium. For example, water, a mixture of water and GenosorbN® or GenosorbN® may be used as the liquid absorption medium in the absorber 16. Since the recirculation air, prior to being supplied to the absorber 16, is compressed by means of the compressor 14, the absorber 16 may operate with a particularly high efficiency, i.e. a high rate of absorption.

CO2 loaded absorption medium is discharged from the absorber 16 via an absorption medium discharge line 20. The absorption medium discharge line 20 has a first end connected to the absorber 16 and a second end connected to a desorber 22. Regenerated absorption medium exiting the desorber 22 is directed back to the absorber 16 via an absorption medium supply line 24 having a first end connected to the desorber 22 and a second end connected to the absorber 16. A discharge conveying device 26 is disposed in the absorption medium discharge line 20. The discharge conveying device 26 is designed in the form of a pump and serves to convey CO2 loaded absorption medium exiting the absorber 16 through the absorption medium discharge line to the desorber 22. A supply conveying device 28, which also is designed in the form of a pump, is disposed in the absorption medium supply line 24 and serves to convey regenerated absorption medium exiting the desorber 22 through the absorption medium supply line 24 to the absorber 16.

The desorber 22 is operated under a reduced pressure of approximately 0.2 bar. This allows a particularly high rate of desorption to be achieved. Specifically, the desorber 22 is disposed in an unpressurized region of the aircraft and hence, during flight operation of the aircraft, is exposed to the reduced pressure prevailing in the unpressurized region of the aircraft when the aircraft is flying at high altitude. In dependence on the operating conditions, the desorber 22 may achieve a desorption efficiency of approximately 80 to 100%.

In order to improve the desorption efficiency in the desorber 22, a pre-heater 28 is disposed in the absorption medium discharge line 20 downstream of the discharge conveying device 26. The pre-heater 30 serves to pre-heat the CO2 loaded absorption medium prior to being supplied to the desorber 22. Typically, when the aircraft is flying a cruising altitude, the low operating pressure of the desorber 22 is sufficient so to as to achieve the desired rate of desorption and desorption efficiency. When, however, the desorber 22 is operated while the aircraft is on the ground, pre-heating the CO2 loaded absorption medium by means of the pre-heater 30 allows to still achieve the desired rate of desorption and desorption efficiency.

A cooler 32 is disposed in the absorption medium supply line 24 downstream of the supply conveying device 28. The cooler 32 serves to cool the regenerated absorption medium flowing through the absorption medium supply line 24 to a desired temperature prior to directing the regenerated absorption medium back to the absorber 16. Finally, the flow of CO2 loaded absorption medium flowing through the absorption medium discharge line 20 and the flow of regenerated absorption medium flowing through the absorption medium supply line 24 are brought into thermal contact with each other in a heat exchanger 34. Specifically, in the heat exchanger 34, heat is transferred from the regenerated absorption medium flowing through the absorption medium supply line 24 to the CO2 loaded absorption medium flowing through the absorption medium discharge line 20 allowing both, a further cooling of the regenerated absorption medium and a pre-heating of the CO2 loaded absorption medium.

The desorber 22 is connected to a ram air channel 36. A flow of ram air from the ram air channel 36 to the desorber 22 may be controlled by a suitable valve (not shown). The ram air supplied to the desorber 22 from the ram air channel 36 serves to purge CO2 desorbed from the absorption medium from the desorber 22. The CO2, together with a ram air purge flow, is discharged from the desorber 22 via a CO2-purge line 38. For example, the mixture of ram air and CO2 flowing through the CO2-purge line 38 may have a CO2 content of approximately 3.96%.

The CO2-purge line 38 opens into an ambient air supply line 40 which connects a fuel tank inerting system 42 to the ambient atmosphere. Ambient air is supplied to the fuel tank inerting system 42 via the ambient air supply line 40. Within the fuel tank inerting system 42, the O2-content of the air is reduced so as to generate an inflammable gas mixture which is supplied to a fuel tank 44 via an inert gas supply line 41. The introduction of CO2-rich gas from the CO2-purge line 38 into the inert gas supply line 40 upstream of the fuel tank inerting system 42 increases the CO2 content of the gas stream supplied to the fuel tank inerting system 42.

Recirculation air exiting the absorber 16 is supplied back to the aircraft cabin 11 via a recirculation air discharge line 46. An air processing device 48 is disposed in the recirculation air discharge line 46. The air processing device 48 is connected to the fuel tank inerting system 42 via an O2-supply line 50. O2 which is generated in the fuel tank inerting system 42 as a waste product thus is reused in the air processing device 48 so as to enrich the recirculation air exiting the absorber 16 with O2. The gas stream directed from the fuel tank inerting system 42 to the air processing device 48 may have an O2-content of up to approximately 35%. Thus, recirculation air exiting the absorber and containing approximately 20.1% O2 and approximately 0.04% CO2, after treatment in the air processing device 48, exits the air processing device 48 with a content of approximately 21% 02 and approximately 0.04% CO2.

Downstream of the air processing device 48, a further heat exchanger 52 is disposed in the recirculation air discharge line 46. The further heat exchanger 52 serves to cool the recirculation air flowing through the recirculation air discharge line 46 to a temperature suitable for allowing the recirculation air to be directed back to the aircraft cabin 11. Downstream of the further heat exchanger 52, a water separator 54 is disposed in the recirculation air discharge line 46. The water separator 54 is designed in the form of a high pressure water separator and serves to separate water condensed from the recirculation air flow upon cooling in the further heat exchanger 52 as well as residual liquid absorption medium from the recirculation air flow.

Finally, the recirculation air flow flowing through the recirculation air discharge line 46 is directed over a turbine 56. The turbine 56 serves to expand the recirculation air to a pressure at which the recirculation air may be directed back to the aircraft cabin 11, rather directly or via a mixing chamber. The turbine 56 and the compressor 14 are disposed on a common shaft. As a result, the compressor 14 may be driven by the turbine 56, hence allowing the output of a motor 58 for driving the compressor 14 to be operated with less output.

As is apparent from the foregoing specification, the invention is susceptible of being embodied with various alterations and modifications which may differ particularly from those that have been described in the preceding specification and description. It should be understood that I wish to embody within the scope of the patent warranted hereon all such modifications as reasonably and properly come within the scope of my contribution to the art.

1. A system for processing recirculation air discharged from an aircraft cabin, the system comprising:
a recirculation air supply line being connectable to the aircraft cabin so as to allow a flow of recirculation air discharged from the aircraft cabin therethrough,
an absorber connected to the recirculation air supply line and being adapted to remove CO₂ from the recirculation air flowing through the recirculation air supply line by absorption of CO₂ in an absorption medium,
a recirculation air discharge line connected to the absorber and being connectable to the aircraft cabin so as to allow a flow of absorption treated recirculation air exiting the absorber to the aircraft cabin, and
an air processing device disposed in the recirculation air discharge line, being connected to an O₂-source and being adapted to enrich the recirculation air exiting the absorber with O₂.

2. The system according to claim 1, wherein the O₂-source is a fuel tank inerting system.

3. The system according to claim 1, further comprising at least one of:
an absorption medium discharge line having a first end connected to the absorber and a second end connected to a desorber so as to allow a flow of CO₂ loaded liquid absorption medium from the absorber to the desorber, and
an absorption medium supply line having a first end connected to the desorber and a second end connected to the absorber so as to allow a flow of regenerated liquid absorption medium from the desorber to the absorber,
wherein the desorber is connectable to the ambient atmosphere and adapted to operate under a reduced ambient pressure prevailing in an unpressurized region of an aircraft during flight operation of the aircraft.

4. The system according to claim 3, wherein at least one of:
at least one of a discharge conveying device and a pre-heater is disposed in the absorption medium discharge line,
at least one of a supply conveying device and a cooler is disposed in the absorption medium supply line, and
the absorption medium discharge line is thermally coupled to the absorption medium supply line.

5. The system according to claim 3, wherein the desorber is connected to at least one of:
a ram air channel so as to allow a flow of ram air through the desorber and to thus purge CO₂ desorbed from the absorption medium from the desorber, and
a fuel tank inerting system so as to allow CO₂ purged from the desorber to be supplied to the fuel tank inerting system.

6. The system according to claim 1, further comprising at least one of:
a compressor disposed in the recirculation air supply line and being adapted to compress the recirculation air flowing through the recirculation air supply line, and
a turbine disposed in the recirculation air discharge line and being adapted to expand the recirculation air flowing through the recirculation air discharge line.

7. The system according to claim 1, further comprising:
a heat exchanger disposed in the recirculation air supply line and being adapted to cool the recirculation air flowing through the recirculation air supply line to a first predetermined temperature, the first predetermined temperature being a temperature suitable for optimizing the CO₂ absorption in the absorber, and
a further heat exchanger disposed in the recirculation air discharge line and being adapted to cool the recirculation air flowing through the recirculation air discharge line to a second predetermined temperature, the second predetermined temperature being a temperature suitable for allowing the recirculation air to be directed to the turbine and, thereafter, to the aircraft cabin.

8. The system according to claim 1, further comprising:
a water separator disposed in the recirculation air discharge line.

9. A method for processing recirculation air discharged from an aircraft cabin, the method comprising the steps:
guiding a flow of recirculation air discharged from the aircraft cabin through a recirculation air supply line,
removing CO₂ from the recirculation air flowing through the recirculation air supply line in an absorber by absorption of CO₂ in an absorption medium,
guiding a flow of absorption treated recirculation air exiting the absorber through a recirculation air discharge line to the aircraft cabin, and
enriching the recirculation air exiting the absorber with O₂ by means of an air processing device which is disposed in the recirculation air discharge line and which is connected to an O₂ source.

10. The method according to claim 9, wherein the O₂ source is a fuel tank inerting system.

11. The method according to claim 9, further comprising at least one of the steps:
guiding a flow of CO₂ loaded liquid absorption medium from the absorber to a desorber through an absorption medium discharge line having a first end connected to the absorber and a second end connected to the desorber,
guiding a flow of regenerated liquid absorption medium from the desorber to the absorber through an absorption medium supply line having a first end connected to the desorber and a second end connected to the absorber, wherein the desorber is connectable to the ambient atmosphere and adapted to operate under a reduced ambient pressure prevailing in an unpressurized region of an aircraft during flight operation of the aircraft,
conveying the CO₂ loaded absorption medium from the absorber through the absorption medium discharge line by means of a discharge conveying device,
pre-heating the CO₂ loaded absorption medium flowing through the absorption medium discharge line by means of a pre-heater,
conveying the flow of regenerated absorption medium from the desorber through the absorption medium supply line by means of a supply conveying device,
cooling the regenerated absorption medium flowing through the absorption medium supply line by means of cooler, and
transferring heat from the regenerated absorption medium flowing through the absorption medium supply line to the CO₂ loaded absorption medium flowing through the absorption medium discharge line.

12. The method according to claim 11, further comprising at least one of the steps:
guiding a flow of ram air from a ram air channel through the desorber so as to purge CO₂ desorbed from the absorption medium from the desorber, and
supplying CO₂ purged from the desorber to a fuel tank inerting system.

13. The method according to claim 9, further comprising at least one of the steps:
compressing the recirculation air flowing through the recirculation air supply line by means of a compressor disposed in the recirculation air supply line,
expanding the recirculation air flowing through the recirculation air discharge line by means of a turbine disposed in the recirculation air discharge line.

14. The method according to claim 9, further comprising at least one of the steps:
cooling the recirculation air flowing through the recirculation air supply line to a first predetermined temperature by means of a heat exchanger disposed in the recirculation air supply line, the first predetermined temperature being a temperature suitable for optimizing the CO₂ absorption in the absorber, and
cooling the recirculation air flowing through the recirculation air discharge line to a second predetermined temperature by means of a further heat exchanger disposed in the recirculation air discharge line, the second predetermined temperature being a temperature suitable for allowing the recirculation air to be directed to the turbine and, thereafter, to the aircraft cabin.

15. The method according to claim 9, further comprising the step:
separating water from the recirculation air flowing through the recirculation air discharge line by means of a water separator disposed in the recirculation air discharge line.
